(19) United States
(12) Patent Application Publication
(10) Pub. No.: US 2011/0002763 A1
(43) Pub. Date: Jan. 6, 2011

(54) MOTOR VEHICLE HAVING AN EXTENDABLE RAMP

(75) Inventors: Tony Earl, Oberursel (DE); Lee Tyler, Ruesselsheim (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/676,572

(22) PCT Filed: Sep. 5, 2008
(86) PCT No.: PCT/EP08/07261

§ 371 Date: Jul. 9, 2010

(30) Foreign Application Priority Data
Sep. 5, 2007 (DE) 102007042132.1

(51) Int. Cl. B60P 1/00

(52) U.S. Cl. 414/523

(57) ABSTRACT

A motor vehicle, in particular a passenger car, is provided that includes, but is not limited to a loading space for a load, in particular for a personal transportation vehicle, that includes, but is not limited to a standing platform and a column which may be shortened. The loading space is disposed in front of a rear fender of the motor vehicle, and includes, but is not limited to an extendable ramp. The ramp is mounted in a linear guide at an angle (α) with respect to the vehicle longitudinal axis so that it may be extended obliquely downward.

### CROSS-REFERENCE TO RELATED APPLICATIONS

This application is a U.S. National-Stage entry under 35 U.S.C. §371 based on International Application No. PCT/EP2008/007261, filed Sep. 5, 2008, which was published under PCT Article 21(2) and which claims priority to German Application No. 102007042132.1, filed Sep. 5, 2007, which are all hereby incorporated in their entirety by reference.

### TECHNICAL FIELD

The present invention relates to a motor vehicle, in particular a passenger car, having a loading space for a load and having an extendable ramp.

### BACKGROUND

In present-day passenger cars, for safety reasons and also for aerodynamic and design aspects, the rear fenders are in some cases drawn far upward. If the space in front of the rear fender is now to be used for stowing loads, when loading a loading space located in front of the rear fender, this load must be raised over the rear fender and lowered in front of said rear fender into the loading space, when unloading accordingly in the reverse sequence. The stowing of cumbersome or heavy loads in a loading space which is disposed not over but in front of the rear fender, in particular a loading space whose bottom is located substantially at the height of the rear fender or even there under, is correspondingly difficult.

Therefore, known, for example, from DE 102 25 482 A1 are passenger cars having a lowerable tailgate which may be folded down by a complex mechanism and lowered behind the rear fender in order to raise the load to a height above the rear fender by reversing the movement sequence.

Alternatively to this, DE 102 13 307 A1 proposes a passenger car, which has an extendable ramp which may be raised above a loading edge by means of a guide linkage and may then be extended horizontally rearward. While reversing the movement sequence, a load positioned on the extended ramp may thus be lowered in front of the loading edge into a loading space in front of the rear fender of the passenger car. This solution also requires complex kinematics and additionally necessitates unnecessary lifting work and unfavorable lever ratios as a result of moving over the rear fender.

Known from DE 103 38 724 A1 is an extension disposed in the region of the rear fender which allows the take-up of loads outside the passenger car in a usage position pulled out rearward from the passenger car. In this solution, the space in front of the rear fender is used for stowing the retracted extension, the required lifting work for positioning the load being reduced at the same time, since this only needs to be raised to the height of the rear fender. However, this solution has the known disadvantages of a loading space provided outside a passenger car, in particular the exposure of the load to environmental influences, the susceptibility of the unsecured load to theft, and the risk of a load working loose in the event of vibrations or an impact.

Known from U.S. Pat. No. 5,971,091 is a personal transportation vehicle comprising a standing platform and a column which may be shortened. Such so-called segways are designed for covering short distances, for example, for delivering goods in inner-city areas or as sports equipment. However, they are unsuitable for covering greater distances and should therefore be conveyed by a motor vehicle. In order to explain the present invention, reference is made hereinafter in particular to this segway as load which is to be transported by a motor vehicle. However, the present invention is not restricted to motor vehicles having a loading space for such segways, but is merely particularly well-suited for this purpose.

Known from WO 2004/078603 A2 for conveying such segways is a motor vehicle having an extendable ramp, over which a segway may be driven onto the rear of the motor vehicle above a rear fender and fastened there. This solution combines the disadvantages of the previously explained prior art: on the one hand, the segway must be raised over the rear fender of the motor vehicle while performing corresponding lifting work. On the other hand, this segway is fastened to the outside of the motor vehicle during transport and therefore particularly exposed to environmental influences, the risk of theft, and loss.

Therefore, at least one object of the present invention is, starting from DE 102 13 307 A1, to provide a motor vehicle, in particular a passenger car, having a loading space for a load, in which it is possible to stow load in a loading space in front of a rear fender of the motor vehicle in a simple manner. In addition, other objects, desirable features, and characteristics will become apparent from the subsequent summary and detailed description, and the appended claims, taken in conjunction with the accompanying drawings and this background.

### SUMMARY

A motor vehicle according to an embodiment of the present invention has a loading space for a load which is disposed in front of a rear fender of the motor vehicle. A loading space disposed in front of the rear fender extends in the direction of the vehicle vertical axis preferably substantially in the region of the rear fender, i.e., from a plane lying in the vicinity of a lower edge of the rear fender as far as a plane running in the vicinity of an upper edge of the rear fender.

The motor vehicle according to an embodiment of the invention further comprises an extendable ramp, which is mounted in a linear guide at an angle with respect to the vehicle longitudinal axis so that it may be extended obliquely downward. The angle of the direction of extension of the ramp with respect to the vehicle longitudinal axis may preferably lie in the range between approximately 15° and approximately 45° , in particular between approximately 20° and approximately 35° . These ranges constitute a particularly favorable compromise between required extension length and height of the ramp.

Due to the extendable ramp, load may be loaded directly into a loading space disposed in front of the rear fender of the motor vehicle or unloaded from said loading space. Complex kinematics and additional lifting work for raising the load over an upper edge of the rear fender may thereby be avoided. On the other hand, the load may be mounted securely, i.e., largely protected from environmental influences and thefts. As a further advantage, hitherto barely accessible space in front of the rear fender of the motor vehicle may thus be used as loading space. This is particularly advantageous if the passenger car has a wide track, narrow wheels, and/or a compound crank rear axle so that a large amount of vehicle interior is present in front of the rear fender. In particular, for example, the space required hitherto for mounting a full-size spare wheel may thus be utilized.

The linear guide may be configured in any manner known to the person skilled in the art. In a preferred embodiment, the ramp comprises for this purpose laterally disposed support profiles which are mounted linearly, i.e., rectilinearly displaceably in corresponding guide profiles. The guide rails may be fastened to the vehicle frame, a vehicle body, a C-pillar of the motor vehicle, the rear fender, or the like, or may be configured integrally with these. Friction and/or roller bearings are considered as mounting.

The ramp may be retracted and extended manually. Preferably, however, a drive is provided by which means the ramp is retracted and extended. This drive may be accomplished electromechanically, for example, by means of an electric motor. This may retract and extend the ramp, for example, by means of conveyor chains, toothed racks, cables, or the like. Equally well, the drive may also be configured hydraulically and the ramp retracted and extended, for example, by means of telescopic cylinders. Such telescopic cylinders may at the same time form the linear guide of the ramp.

The drive may be controlled from the vehicle interior, for example, by means of a control element on the instrument panel and/or by remote control, for example, by means of an electronic vehicle door opener.

The ramp may extend through under the rear fender for taking up flat loads. Preferably, however, the path of the ramp runs through a region covered by a section of the rear fender. In this case, the corresponding section of the rear fender may be fastened to the ramp, and retracted and extended together with this, as is explained for example in DE 103 38 724 A1.

In an alternative embodiment of the present invention, the corresponding section of the rear fender of the motor vehicle may be transferred from a driving position in which it is disposed behind the retracted ramp, into a loading position in which it allows an extension and retraction of the ramp and load positioned thereon. To this end, the section of the rear fender may, for example, be folded away to the side or moved upward or downward. In a preferred embodiment, the section of the rear fender may be transferred from the driving position into the loading position by means of a multilinkage mechanism. Such a multilinkage mechanism may, for example, be configured as a parallelogram guide or the like, and make it possible for the section of the rear fender to pivot simultaneously back and over its drive position. This enables even cumbersome loads to be loaded into the loading space and on the other hand does not require any large distance of the motor vehicle from obstacles disposed behind this.

The transfer of the section of the rear fender from its driving into its loading position and back, in particular a corresponding pivoting, may be executed manually, for example, in a manner similar to that known from the opening of a tailgate or a trunk lid of passenger cars. The transfer of the section of the rear fender is, however, preferably accomplished by means of a drive. To this end, a dedicated drive may be provided, which may be synchronized with a drive for retracting and extending the ramp in such a manner that before extending the ramp, the section of the rear fender is transferred into its loading position and after retracting the ramp, is transferred back into its driving position. The section of the rear fender, in particular a corresponding multilinkage mechanism, may preferably be coupled to the extendable ramp in such a manner that the retraction or extension of the ramp effects a corresponding movement of the section of the rear fender. To this end, forced guides, for example, in the form of guide linkages, Bowden cables, control chains, or the like, may be provided.

In a preferred embodiment of the present invention, at its rear end facing away from the motor vehicle, the ramp has a pivotable end section which may be transferred from a loading position with ramp extended into a driving position pivoted toward the loading space compared with the loading position, with ramp retracted. The end section may be fastened to the ramp, for example, by means of swivel joints. Due to the pivoting into the driving position toward the loading space, the load, preferably in the last section of the retraction movement of the ramp, is raised so that the motor vehicle has a greater ground clearance and the load is in any case positioned substantially in front of the rear fender. At the same time, the travel of the ramp in the direction of the vehicle longitudinal axis which is required for raising the load into the loading space as a result of the oblique linear guidance of the ramp, may be shortened.

The transfer of the pivotable end section into the driving position may be accomplished manually, by means of a dedicated drive, or preferably forcibly. To this end, a run-in slope or the like may be provided in such a manner that during retraction of the ramp, the end section is positively pivoted into the driving position by running onto the run-in slope. During extension of the ramp, after leaving the run-in slope, the end section then pivots downward under its own weight into the loading position in which it forms, for example, substantially a continuous, preferably flat, surface with the ramp. A pivoting of the end section beyond its loading position may be delimited by corresponding stops or the like, and thus the loading position sufficiently precisely defined.

In addition, clamping means, for example, torsion springs or the like, may pretension the end section in its loading, driving, or an intermediate position.

At its end facing away from the motor vehicle, the ramp preferably has a stop which prevents the load slipping down the obliquely positioned ramp. This stop must be overcome for loading and unloading. This is particularly easy with rollable loads such as the segways specified initially.

Securing means may also be provided for fixing the retracted ramp. Such a securing means may, for example, in the form of hydraulic or spring-loaded hooks, latch into corresponding recesses on the ramp. The securing means may be released for extending the ramp actively, for example, manually or automatically, for example, in a forcibly coupled manner through a pivoting of the section of the rear fender.

The loading space which is disposed in front of the rear fender and loaded by the extendable ramp is preferably separated from a trunk of the motor vehicle by means of a trunk base. This prevents any falling of goods from the trunk into the loading space. Advantageously, the loading space is then not easily visible from outside. Such a trunk space is particularly advantageous if the loading space is not sealed from the surroundings and is used for transporting load which is not sensitive to dirt or moisture from the underside of the vehicle. In this case, the trunk base can separate the trunk from the external surroundings of the motor vehicle.

The loading space may be disposed next to a trunk of the motor vehicle. The loading space is preferably disposed in front of the rear fender but under a trunk of the motor vehicle, so that load may be stowed in the usual manner above the rear fender in the trunk and, additionally, in the loading space in front of the rear fender.

As stated initially, a motor vehicle according to one embodiment of the present invention is particularly suitable for transporting so-called segways. To this end, the loading space may be dimensioned for accommodating one or two such segways. The loading space is preferably dimensioned in such a manner that the segways may only be accommodated with a shortened column. This allows a correspondingly flat loading space so that a trunk located there above is reduced in size as little as possible.

### BRIEF DESCRIPTION OF THE DRAWINGS

The present invention will hereinafter be described in conjunction with the following drawing figures, wherein like numerals denote like elements, and:

FIG. 1 shows the kinematic structure of an extendable ramp of a motor vehicle according to one embodiment of the present invention in the extended state;

FIG. 2 shows the ramp according to FIG. 1 in the refracted state;

FIG. 3 shows in perspective view a part of a motor vehicle according to one embodiment of the present invention with extended ramp and two loaded segways;

FIG. 4 shows a longitudinal section of the part of the motor vehicle according to FIG. 3;

FIG. 5 shows a section of a part of the vehicle from FIG. 3 in plan view;

FIG. 6 shows the rear region of the vehicle from FIG. 3 in partial section; and

FIG. 7 shows the rear lower region from FIG. 6 in the loading position (continuous line) or driving position (dashed line).

### DETAILED DESCRIPTION

The following detailed description is merely exemplary in nature and is not intended to application and uses. Furthermore, there is no intention to be bound by any theory presented in the preceding background or summary or the following detailed description.

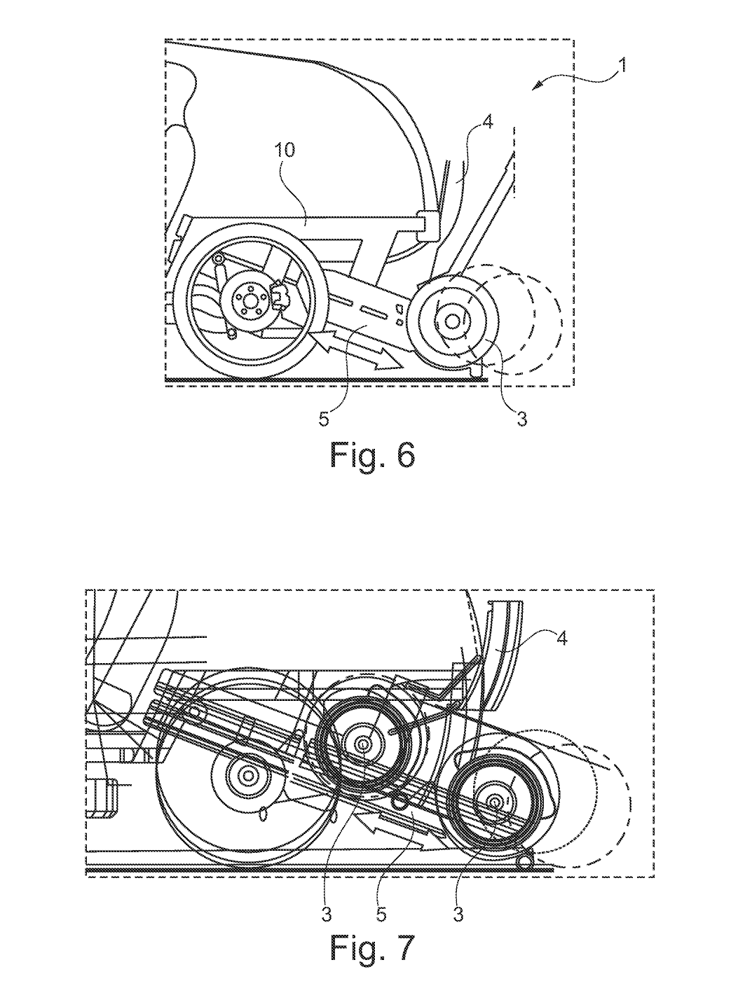

FIG. 6 shows the rear portion of a motor vehicle 1 according to one embodiment of the present invention in a partial section in a loading position in which the extendable ramp 5 is extended and a load in the form of a segway 3 is positioned on its rear end section. In order to allow the extension of the ramp, a section of a rear fender 4 of the motor vehicle 1 is pivoted away rearwardly upward by means of a multilinkage mechanism identifiable in FIG. 7. By retracting the extendable ramp 5 toward the motor vehicle in the direction indicated by the left-hand tip of the double arrow, the segway is introduced into a loading space 2 of the motor vehicle, which is separated by a trunk lid 10 from a trunk 11 of the motor vehicle 1 located there over. To this end, as is apparent from FIG. 4 which shows the segway 3 in the loaded state (left in FIG. 4) or with ramp 5 extended (right in FIG. 4), the supports of the segway which are used to operate and stabilize it must be shortened, which may be achieved, for example, by means of a telescopable or foldable support.

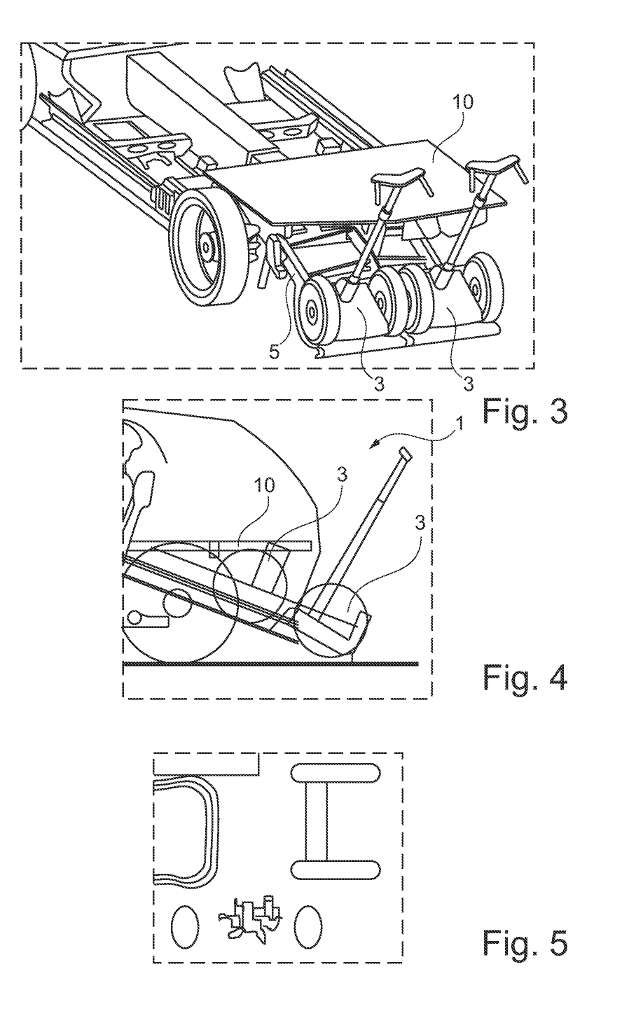

FIG. 3 shows the loading situation shown in FIG. 6 in perspective view with two segways 3 disposed adjacent to one another on the ramp 5.

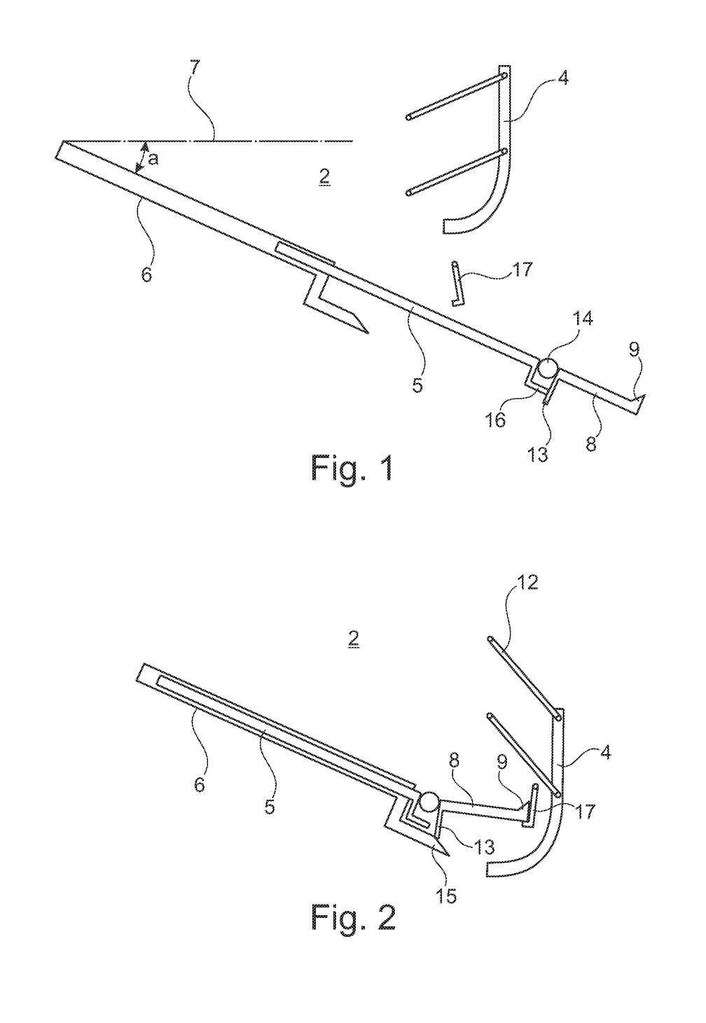

The retraction and extension of the ramp 5 is now explained in detail with reference to FIG. 1 and FIG. 2. Starting from the retracted ramp 5 shown in FIG. 2, this is extended by means of a drive (not shown) in a linear guide 6 (toward the right in FIG. 2). To this end, the section of the rear fender 4 of the motor vehicle 1 pivots rearwardly upward and thus allows an extending movement of the ramp 5. To this end, the multilinkage mechanism 12 configured as a parallelogram in FIG. 2 is coupled to the drive of the extendable ramp 5 in such a manner (not shown) that the section of the rear fender 4 is pivoted rearwardly upward when an extending movement of the extendable ramp 5 is initiated from the driving position depicted in FIG. 2, wherein advantageously the section of the rear fender 4 is initially pivoted fully upward before the ramp 5 is moved in its linear guide 6. On reversing the direction of movement, the section of the rear fender 4 is accordingly pivoted back into its driving position shown in FIG. 2 after the ramp 5 is fully retracted in its linear guide 6, i.e., has adopted its driving position.

The linear guide 6 is inclined at an angle a of approximately 25° with respect to the vehicle longitudinal axis 7 so that the ramp 5 may extend rearwardly downward in the linear guide 6 obliquely relative to the motor vehicle 1.

After the section of the rear fender 4 has been pivoted away, the ramp 5 extends rearwardly downward in its linear guide 6 at the angle α. To this end, the drive may, for example, apply pressure to telescopic cylinders (not shown) which extend the ramp 5. Alternatively, for example, an electric motor may drive a pinion which engages in a rack (not shown) on the ramp 5 and extends or retracts this in its linear guide 6.

In the driving position shown in FIG. 2, a shoulder 13 disposed on the underside of an end section 8, which is pivotably fastened on the ramp 5 by means of a swivel joint 14, rests on a run-in slope 15 so that the end section 8 is pivoted in its swivel joint 14 toward the loading space 2, i.e., upward.

When the ramp 5 extends (to the right in FIG. 2), the shoulder 13 slides on the run-in slope 15 so that the end section 8 pivots downward under its own weight into a loading position until it impinges against a stop 16 on the ramp 5, which prevents any further pivoting of the end section 8 and thus defines its loading position (FIG. 1). The ramp 5 then extends further in its linear guide 6 until an edge of the end section 8 facing away from the vehicle touches a ground contact area of the motor vehicle (not shown).

In this loading position the segways are brought into their loading position shown in FIG. 3 or FIG. 6 on the rear end section 8. To this end, they must roll over a stop 9 on the edge of the end section 8 facing away from the vehicle, which prevents the segways from rolling back and secures these safely on the ramp or in the loading space 2. Further stops, wedges, belts, or the like, may be provided in order to fasten segways or other load on the ramp 5.

The ramp 5 is then retracted in its linear guide 6, for example, by the telescopic cylinders retracting or the electric motor changing its direction of rotation. In this case, in the last section of the retraction movement the shoulder 13 of the end section 8 runs on the run-in slope 15 so that the end section 8 and the segway positioned thereon are additionally raised into the loading space 2. Finally, the section of the rear fender 4 pivots back into its driving position and substantially closes the loading space 2 toward the back.

FIG. 2 shows schematically a securing means 17 in the form of a rotating hook which is coupled to the multilinkage mechanism 12 of the section of the rear fender 4 in such a manner that it reaches under the rear end section 8 when the section of the rear fender 4 is disposed in its driving position (FIG. 2) and releases the end section 8 when the section of the rear fender 4 is pivoted away. This additionally supports the end section 8 and prevents any unintentional extension of the ramp 5.

As shown hereinbefore, in a motor vehicle according to the invention, loads may be loaded in a simple manner into a loading space 2 in front of rear fender 4 of the motor vehicle 1 or unloaded from this without executing unnecessary lifting work. At the same time, the normally unused space which becomes free, for example, when no spare wheel needs to be carried in the trunk, is optimally utilized.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A motor vehicle comprising:
a loading space adapted for a load that is disposed in front of a rear fender of the motor vehicle; extendable ramp mounted in a linear guide at an angle (α) with respect to longitudinal axis of the motor vehicle and extendable obliquely downward.

2. The motor vehicle according to claim 1, wherein the extendable ramp retractable and extendable with a drive.

3. The motor vehicle according to claim 1, wherein a section of the rear fender is transferrable from a driving position in which the section is disposed behind the extendable ramp in a retracted position into a loading position in which the section allows an extension of the extendable ramp.

4. The motor vehicle according to claim 3, wherein the section of the rear fender is be transferrable from the driving position into the loading position with a multilinkage mechanism.

5. The motor vehicle according to claim 1, wherein at an end facing away from the motor vehicle, the extendable ramp comprises a pivotable end section that is transferrable from a loading position with the extendable ramp extended into a driving position pivoted toward the loading space compared with the loading position with the extendable ramp in a retracted position.

6. The motor vehicle according to claim 5, wherein the pivotable end section is adapted for forceable transfer into the driving position when retracting the extendable ramp.

7. The motor vehicle according to claim 1, wherein at an end facing away from the motor vehicle, the extendable ramp has a stop.

8. The motor vehicle according to claim 1, further comprising a securing device adapted to fix the extendable ramp in a retracted position.

9. The motor vehicle according to claim 1, wherein the loading space is separated from a trunk of the motor vehicle by means of a trunk base.

10. The motor vehicle according to claim 9, wherein the loading space is disposed under the trunk of the motor vehicle.

11. The motor vehicle according to claim 1, wherein the loading space is dimensioned for accommodating at least two personal transportation vehicles, each of the at least two personal transportation vehicles having a standing platform and a column that is adapted for shortening.

12. The motor vehicle according to claim 1, wherein the loading space is dimensioned for accommodating a personal transportation vehicles comprising a standing platform and a column that is adapted for shortening.

13. The motor vehicle according to claim 1, wherein the motor vehicle is a passenger vehicle.
